(19) United States
(12) Patent Application Publication
(10) Pub. No.: US 2019/0315062 A1
(43) Pub. Date: Oct. 17, 2019

(54) METHOD AND SYSTEM FOR PRODUCING AN ARTICLE BY LAYER-BY-LAYER BUILDUP IN A STAMPING PROCESS

(71) Applicant: Covestro Deutschland AG, Leverkusen (DE)

(72) Inventors: Dirk ACHTEN, Leverkusen (DE); Thomas BÜSGEN, Leverkusen (DE); Christoph TOMCZYK, Leverkusen (DE); Roland WAGNER, Leverkusen (DE); Bettina METTMANN, Dormagen (DE); Dirk DIJKSTRA, Odenthal (DE); Levent AKBAS, Witten (DE); Arnaud GUEDOU, Bailly Romainvilliers (FR)

(21) Appl. No.: 16/462,268

(22) PCT Filed: Nov. 22, 2017
(86) PCT No.: PCT/EP2017/080008

§ 371 Date: May 20, 2019

(30) Foreign Application Priority Data
Nov. 22, 2016 (EP) 16199955.2

(51) Int. Cl. B29C 64/264; B29C 64/153

(52) U.S. Cl. CPC B29C 64/264; B33Y 30/00; B29C 64/153

(57) ABSTRACT

A method for producing an article in which a layer (200) of meltable polymer is selectively melted at least partially. This takes place according to a selected cross section of the article to be formed. The at least partially melted material is added on layer by layer to a carrier (500) or to previous layers bonded to the carrier (500). A system that is suitable for carrying out the method according to the invention has a substrate (100), a control unit (600), an application unit (700) for applying the particles to the substrate (100), an energy exposure unit (700) and a contacting unit (800).

The present invention relates to a process for producing an article in which a layer comprising meltable polymer is selectively at least partially melted. This is carried out according to a selected cross section of the article to he formed. The at least partially molten material is bonded ply by ply to a carrier or to preceding plies joined to the carrier. A system which is suitable for performing the process according to the invention comprises a substrate, a control unit, an application unit for the particles onto the substrate, an energizing unit and a contacting unit.

Additive manufacturing processes are processes by means of which articles are constructed in layer-wise fashion. They therefore differ markedly from other processes for producing articles such as milling, drilling or material removal. In the latter methods, an article is processed such that it obtains its final geometry by removal of material.

Additive manufacturing processes utilize different materials and process techniques to effect layer-wise construction of articles. In fused deposition modeling (FDM), for example, a thermoplastic wire is liquefied and deposited layer-wise on a movable construction platform using a nozzle. Upon solidification a solid article is formed. The nozzle and construction platform are controlled based on a CAD drawing of the article. If the geometry of this article is complex, for example with geometric undercuts, support materials additionally have to be printed and, after completion of the article, removed again.

Also in existence are additive manufacturing processes which utilize thermoplastic powders to effect layer-wise construction of articles, in these, a so-called coater applies thin layers of powder which are then selectively melted using an energy source. The surrounding powder supports the component geometry. Complex geometries can thus be manufactured more economically than in the above-described FDM method. Moreover, different articles may be arranged or manufactured in a tightly packed manner in the so-called powder bed. Owing to these advantages, powder-based additive manufacturing processes are among the most economically viable additive manufacturing processes on the market. They are therefore the processes that are predominantly used by industrial users. Examples of powder-based additive manufacturing processes are so-called selective laser sintering (SLS) or high-speed sintering (HSS). They differ from one another in the method for introducing into the plastic the energy for the selective melting. In the laser sintering process energy input is effected via a deflected laser beam. In the so-called high-speed sintering (HSS) process (EP 1648686) energy input is effected via infrared (IR) emitters in combination with an IR absorber selectively printed into the powder bed. So-called selective heat sintering (SHS) utilizes the printing unit of a conventional thermal printer to selectively melt thermoplastic powders.

Though not belonging to the additive manufacturing processes as such, transfer or tampon printing processes are used fur construction of electronic elements in the semiconductor industry. Thus, EP 1 713 311 Al discloses a process and an apparatus for producing an electronic integrated circuit using functional ink and a rotating roll-to-roll pressing procedure. The process includes a first step of injection of functional ink into a depression in a molding roll, a second step of removing ink from the surface of the molding roll, a third step of drying the functional ink injected into the molding roll, a fourth step of transferring the dried surface of the functional ink onto a printing roll, a fifth step of drying a further surface of the functional ink transferred onto the printing roll, a sixth step of transferring the functional ink from the printing roll onto flexible printing paper which is unwound from a roll and a seventh step of winding the printing paper onto which an electronic circuit has been printed onto a winding roll.

WO 2003/059026 A1 discloses a process for producing an electrical circuit comprising the steps of; supplying a substrate to a transfer printing means; supplying a carrier provided with a material between the transfer printing means and the substrate, wherein the material comprises an electrically functional polymer material; structured transferring of at least a portion of the material from the carrier to the substrate using the transfer printing means; and affixing the material having undergone structured transferring to the substrate to obtain a defined structure of affixed material.

Various, mostly complicated, approaches have hitherto been disclosed for the construction of three-dimensional structures in the context of the additive manufacturing by transfer printing processes.

The utility model CN 204109374 U describes a thermal transfer printing ribbon for three-dimensional printing and a 3D printer comprising this ribbon. The 3D printer comprises a printing platform and a printing head, wherein the distance between the printing platform and the printing head is adaptable.

WO 2012/164015 A1 relates to an additive construction process for producing a plurality of layers to form a stack. In the process a variable potential difference is generated between a conductive element at a first potential and an ion source at a second potential and an electric field is established between the conductive element and the ion source. The electric field penetrates through the stack to the nearest surface of the stack which is nearest to a transfer medium. The process further comprises accumulating an electrical charge from the ion source onto the nearest surface of the stack and transferring deposition material from a transfer medium onto the nearest surface. The field strength at the nearest surface of the stack is controlled to achieve a homogeneous transfer of the deposition material onto the nearest surface.

US 2009/304952 A1 discloses an apparatus for producing three-dimensional objects comprising a tray adapted for holding an object during production; a depositing surface upon which construction materials are deposited and an inkjet printing head adapted for selectively depositing construction materials on the depositing surface in a layer according to a tomographic image. The deposited materials are combined with the object to he produced when the tray moves the article such that it contacts the deposited materials.

WO 2015/07066A1 A1 describes an additive production system for producing a three-dimensional object. A resin applicator is provided for applying a layer of a curable resin on a first side of a film substrate. The film substrate is supported by a transparent support plate and a radiation source for radiation curing of the resin layer is provided. A platform is provided for holding a stacked arrangement of one or more cured resin layers corresponding at least in part to the three-dimensional object and a positioning system is used for the relative positioning of the film substrate and the platform. A mask arranged substantially parallel to the resin layer is present and at least partially blocks incident radiation onto the resin layer according to a cross section of the article.

The described transfer printing processes in the field of additive manufacturing have the disadvantage that they either require complicated apparatus or, as a result of the electrostatic nature of some process steps, are not able to process all thermoplastic materials.

It is an object of the present invention to at least partially overcome at least one disadvantage of the prior art. It is a further object of the invention to provide a simplified additive manufacturing process in which a broad spectrum of materials is employable compared to currently available powder processes. It is a further object of the invention to provide a process and a system by which articles are producible with the greatest possible resource efficiency and customization.

The object is achieved in accordance with the invention by a process as claimed in claim 1. A system for performing the process is specified in claim 14. Advantageous developments are specified in the subsidiary claims. They may be combined with one another as desired unless the opposite is clear from the context,

A process for producing an article comprises the steps of:
I) providing a layer on a substrate, wherein the layer contains a meltable polymer;
II) energizing a selected portion of the layer provided in step I) corresponding to a first selected cross section of the article so that the layer in the selected portion is at least partially melted and at least one at least partially melted volume is obtained;
III) contacting the at least one volume obtained in step II) with a carrier so that the at least one volume is joined to the carrier;
IV) removing the carrier including the at least one volume joined to the carrier from the substrate;
V) providing a further layer on the substrate or on a further substrate, wherein the layer contains a meltable polymer;
VI) energizing a selected portion of the layer provided in step V) corresponding to a further selected cross section of the article so that the layer in the selected portion is at least partially melted and at least one at least partially melted volume is obtained;
VII) contacting the at least one volume obtained in step VI) with at least one of the volumes previously joined to the carrier so that the volume obtained in step VI) is joined to at least one of the volumes previously joined to the carrier;
VIII) removing the carrier including the volumes joined to the carrier from the substrate;
IX) repeating steps V) to VIII) until the article is formed.

The steps I) to IV) in the process according to the invention relate to the construction of the first ply of the article. By contrast, steps V) to VIII) relate to the construction of all further plies. The difference results from the fact that step III) comprises contacting the carrier with the volume formed while step VII) comprises contacting the volumes formed with volumes already adhering to the carrier.

Steps II) and V) of the process comprise providing a layer on a substrate. The layer contains a meltable polymer and thus forms the building material for the article to be produced. In addition to the meltable polymer the layer may also contain further additives such as fillers, stabilizers and the like but also further polymers. The total content of additives in the layer may be for example≥0.1% by weight to≤50% by weight, preferably ≥0.3% by weight to 25% by weight, particularly preferably 0.5% to 15% by weight.

Steps II) and VI) comprise at least partially melting the region of the layer or the meltable polymer present therein according to the selected cross section of the article, It is preferable when all of the meltable material provided therefor is melted. The melting may be carried out for example using deflectable lasers and corresponds to a selected cross section of the article to be produced. Further inventive options for the melting are elucidated hereinbelow. The selecting of the respective cross section is advantageously effected by means of a CAD program, with which a model of the object to be produced has been generated. This operation is also known as “slicing” and serves as a basis for controlling the irradiation. The coherent regions obtained after irradiation of the particle layer are referred to as “volumes” in the context of the present invention.

Steps III) and VII) comprise contacting the volumes to bring about the conditions for their detachment from the substrate. Depending on the solidification and recrystallization behavior of the meltable polymer and thus also its propensity to form a cohesive join with other materials the duration between the end of step II) and the beginning of step III) or the end of step VI) and the beginning of step VII) may be for example ≥0.1 second to ≤60 seconds, preferably ≥0.5 seconds to ≤10 seconds.

The fact that step III) comprises joining at least one volume with the carrier means that a cohesive join is formed between the volume and the carrier which makes it possible to move the volumes in a subsequent step. The join between the volumes and the carrier preferably has a strength such that the article to he produced does not detach from the carrier during the process according to the invention while on the other hand the strength of the join preferably allows nondestructive removal of the article after termination of the production process. It is analogously the case in step VII) when the at least one volume is joined to at least one of the volumes previously joined to the carrier that a cohesive join is formed which has a higher strength than an adhesion of the previously produced volume to the substrate,

The detaching itself is carried out according to steps IV) and VIII) by removing the carrier from the substrate. In the simplest case the carrier moves vertically up and down to perform steps III)/VII) and IV)/VIII). In order to facilitate the detaching in step IV) the surface of the carrier which contacts the volume or volumes previously obtained by irradiation may he distinct from the surface of the substrate, wherein the adhesion of the volume or of the volumes to the substrate is lower than to the carrier. The same applies to the detaching in step VIII), wherein the adhesion of the previously obtained volume or volumes to volumes already adhering to the carrier is greater than to the substrate Suitable materials for the substrate are for example materials having a low surface energy such as PTFE and fluorinated or siliconized surfaces of papers, metals or polymers. A suitable material for the carrier is for example steel, paper or a double-sided adhesive tape having a suitable adhesive layer facing the substrate. In one particular embodiment this adhesive layer may subsequently he removed from the product by various known procedures such as washing, material-removing processes and dissolving, and in a further preferred embodiment said layer remains on the contact points of the product.

It is preferable when in step I) and/or in step V), the thickness of the layer is ≥1 μm to ≤1000 μm. The thickness of the layer is preferably ≥10 μm to ≤500 μm, more preferably ≥20 μm to ≤300 μm. The resolution in the construction plane (xy plane) is preferably ≤500 μm, particularly preferably <200 μm.

The process according to the invention may he performed in the normal ambient atmosphere or else in a controlled, air-conditioned atmosphere,

In a preferred embodiment the steps II) and/or VI) are performed such that the energizing of the selected portion of the layer is carried out by irradiation with an energy beam or a plurality of energy beams. This process form may be regarded as a variant of a selective sintering process, in particular as a selective laser sintering process (SLS). The energy beam (or energy beams) may be a beam of electromagnetic energy such as for example a “light beam” of UV to IR light. The energy beam is preferably a laser beam, particularly preferably having a wavelength between 600 nm and 15 μm. The laser may be a semiconductor laser or a gas laser. An electron beam is also conceivable.

In a further preferred embodiment the steps II) and/or VI) are performed such that they comprise initially applying a liquid onto the selected portion of the layer, wherein the liquid increases the absorption of energy in the regions of the layer contacted by it relative to the regions not contacted by it, and subsequently subjecting the layer to an energy source. This embodiment may comprise for example applying a liquid containing an IR absorber onto the layer using inkjet methods. The irradiation of the layer results in a selective heating or those regions of the layer (in particular when particles are employed) that are in contact with the liquid including the IR absorber. This makes it possible to achieve a joining of the particles. The energy source is in particular a UV to IR emitter. Optionally, it is additionally possible to use a second liquid complementary to the energy-absorbing liquid in terms of its characteristics with respect to the energy used. In regions in which the second liquid is applied, the energy used is not absorbed but reflected. The regions beneath the second liquid are thus shaded. In this way, the separation sharpness between regions of the layer that are to be melted and not to he melted can be increased.

In a preferred embodiment the layer of a meltable polymer present on the substrate is preheated to a temperature of ≥100° C. below its melting point, preferably ≥50° C. below its melting point, before a portion of the layer is selectively melted. For primarily amorphous polymers such as polystyrene or polycarbonate the reference value is the glass transition temperature and for at least semicrystalline polymers such as polyamide 12 the reference is the melting point itself. The preheating may be carried out by conventional methods such as for example hot-air, thermal radiation or thermal convection using for example a heated substrate.

In a further preferred embodiment the steps I) and/or V) are performed such that a layer comprising particles is applied to the substrate, wherein the particles contain a meltable polymer.

A process according to the invention may in particular comprise the steps of:
I) applying a layer comprising particles onto a substrate, wherein the particles contain a meltable polymer;
II) irradiating a selected portion of the layer applied in step I) corresponding to a first selected cross section of the article with an energy beam or a plurality of energy beams so that the particles in the selected portion are at least partially melted and at least one at least partially melted volume is obtained;
III) contacting the volume obtained in step II) or the volumes obtained in step II) with a carrier so that the at least one volume is joined to the carrier;
IV) removing the carrier including the at least one volume joined to the carrier from the substrate;
V) applying a further layer comprising particles onto the substrate, wherein the particles contain a meltable polymer;
VI) irradiating a selected portion of the layer applied in step V) corresponding to a further selected cross section of the article with an energy beam or a plurality of energy beams so that the particles in the selected portion are at least partially melted and at least one at least partially melted volume is obtained;
VII) contacting the at least one volume obtained in step VI) with a volume previously joined to, the carrier or volumes previously joined to the carrier so that the volume obtained in step
VI) is joined to at least one of the volumes previously joined to the carrier;
VIII) removing the carrier including the volumes joined to the carrier from the substrate;
IX) repeating steps V) to VIII) until the article is formed.

When particles are used in the process according to the invention it is preferable for ≥90% by weight of the meltable particles employed in steps I) and/or V) to have a particle diameter of ≥0.001 mm and ≤0.25 mm (preferably ≥0.01 mm and ≤0.2 mm, particularly preferably ≥0.02 mm and ≤0.15 mm).

In a further preferred embodiment the steps I) and/or V) are performed such that a film containing a meltable polymer is provided, wherein the film is arranged on a carrier film as a substrate. Thus, in contrast to powder-based variants, a film is selectively at least partially melted according to the cross section of the article to be produced selected in each case

In a further preferred embodiment of the process according to the invention the contacting in step III) and/or step VII) is performed such that it comprises performing a relative movement of the carrier toward the substrate, monitoring the distance between the carrier and the substrate and/or between the carrier and the surface of the powder layer and interrupting the relative movement upon falling below a predetermined distance. The monitoring of the distance may be carried out for the movement of the carrier for example using ultrasound distance measurement or using calibrated distance sensors. A further falling below of the distance between the piston and the substrate or the surface of the powder layer would result in compression of the volumes previously obtained by melting, which could destroy fine structures.

In a further preferred embodiment of the process according to the invention the contacting in step III) and/or step VII) is performed such that it comprises performing a relative movement of the carrier toward the substrate, monitoring the contact pressure between the carrier and the substrate and/or between the carrier and the surface of the powder layer and interrupting the relative movement upon exceedance of a predetermined contact pressure. The monitoring of the contact pressure may be carried out for example by pressure measurement at the carrier. A further exceeding of the contact pressure between the carrier and the substrate or the surface of the powder layer would result in compression of the volumes previously obtained by melting, which could destroy fine structures. The achieved average pressure over the entire contacted area may typically he between 0.01 bar and 5 bar.

In a further preferred embodiment of the process according to the invention the meltable polymer is selected such that a droplet of the meltable polymer in the molten state has a contact angle to the substrate used in the process of ≥60° to ≤80′ (preferably ≥70° to ≤150°, more preferably ≥90′ to ≤150° and/or the meltable polymer is selected such that a droplet of the meltable polymer in the molten state has a contact angle to the carrier used in the process of ≥0° to ≤90° (preferably ≥10° to ≤80°, more preferably ≥20° to ≤60′). Thus the molten polymer wets the surface of the substrate poorly while the surface of the carrier is well wetted. The contact angle may be determined by optical methods such as are familiar in methods for determining surface energies. The contact angle measurement or a measurement of comparable usefulness is typically carried out at a temperature of 20° C. or more above the melting point of the polymers investigated.

In a further preferred embodiment of the process according to the invention, the steps II) and/or VI) are performed such that the at least one volume obtained does not contact the substrate. This can be achieved for example by reducing the power of a laser used for irradiation and/or reducing the time for which the laser energizes a certain region. Another option is a non-melting particle layer above the substrate. When particles are still present between the volume or volumes and the substrate the adhesion between the volume or volumes and the substrate becomes practically nonexistent. This simplifies the detaching from the substrate considerably.

In a further preferred embodiment of the method according to the invention the steps II) and/or VI) are performed such that after the at least partial melting of the particles their molten material at a temperature of ≥20° C. above the melting point of their material has a storage modulus G′ (determined by viscometric measurement with a plate/plate oscillation shear viscometer at an angular frequency of 1/s) of ≥5·10³ Pa to ≤1·10⁷ Pa (preferably ≥1·10⁴ Pa to ≤5·10⁶ Pa, particularly preferably ≥5·10⁴ Pa to 1·10⁶ Pa). This may be achieved by appropriate control of the laser in respect of power and power density. At the chosen storage moduli it can be expected that the material is tacky and therefore readily joins to carriers or previously formed volumes.

In a further preferred embodiment of the process according to the invention the steps III) and/or VII) are performed such that volumes previously joined to the carrier have a storage modulus G′ (determined by viscometric measurement with a plate/plate oscillation shear viscometer at an angular frequency of 1/s) of 1·10⁷ Pa (preferably 1·10⁸ Pa). At such a storage modulus it can be expected that the material is no longer sticky and under the conditions prevailing in the process will adhere neither to the substrate nor to the unmelted product.

In a further preferred embodiment of the process according toe the invention the meltable polymer is selected from the group consisting of polyurethane, polyester, polyalkylene oxide, plasticized PVC, polyamide, protein, PEEK, PEAK, polypropylene, polyethylene, thermoplastic elastomer, POM, polyacrylate, polycarbonate, polymethylmethacrylate, polystyrene or a combination of at least two of these.

In a further preferred embodiment of the process according to the invention the meltable polymer is a thermoplastic elastomer and has a melting range (DSC, differential scanning calorimetry; second heating at a heating rate of 5 K/min) of ≥20° C. to ≤240° C. (preferably ≥40° C. to ≤220° C., more preferably ≥70° C. to ≤200° C.), a Shore A hardness according to DIN ISO 7619-1 of ≥40 to and ≤85 Shore D (preferably ≥50 Shore A to ≤80 Shore D, more preferably ≥60 Shore A to ≤75 Shore D) and a melt volume rate (MVR) according to ISO 1133 (190° C., 10 kg) of ≥25 to ≤200 (preferably ≥30 to ≤150, more preferably ≥35 to ≤100) cm³/10 min.

In this DSC analysis, the material is subjected to the following temperature cycle: 1 minute at minus 60° C., then heating to 240° C. at 20 kelvin/minute, then cooling to minus 60° C. at 5 kelvin/minute, then 1 minute at minus 60° C., then heating to 240° C. at 20 kelvin/minute.

In a further preferred embodiment of the process according to the invention the meltable polymer is a thermoplastic elastomer and has a melting range (DSC, differential scanning calorimetry; second heating at a heating rate of 5 K/min) of ≥20° C. to ≤240° C. (preferably ≥40° C. to ≤220° C., more preferably ≥70° C. to ≤200° C.), a Shore A hardness according to DIN ISO 7619-1 of ≥40 to and ≤Shore 85 D (preferably >50 Shore A to ≤80 Shore D, more preferably ≤60 Shore A to ≤75 Shore D); a melt volume rate (MVR) at a temperature T according to ISO 1133 (10 kg) of 5 to 15 (preferably ≥6 to 12, more preferably ≥7 to ≤10) cm³/10 min and exhibits a change in the melt volume rate (10 kg) at an increase of this temperature T by 20° C., of 90 (preferably ≤70, more preferably ≤50) cm³/10 min.

In this DSC analysis too, the material is subjected to the following; temperature cycle: 1 minute at minus 60° C., then heating to 240° C. at 20 kelvin/minute, then cooling to minus 60° C. at 5 kelvin/minute, then 1 minute at minus 60° C., then heating to 240° C. at 20 kelvin/minute.

This thermoplastic elastomer, preferably a thermoplastic polyurethane elastomer, has uniform melting characteristics. Melting characteristics are determined via the change in MVR. (melt volume rate) according to ISO 1133 at a preheating time of 5 minutes and 10 kg as a function of temperature. Melting characteristics are considered to be “uniform” when the MVR at a starting temperature Tₓ has a starting value of 5 to 15 cm³/10 min and increases by not more than 90 cm³/10 min as a result of an increase in temperature by 20° C., to Tₓ₊₂₀.

In a further preferred embodiment of the use according to the invention the elastomer is a thermoplastic polyurethane elastomer obtainable from the reaction of the following components:

a) at least one organic diisocyanate

b) at least one compound having isocyanate-reactive groups and having a number-average molecular weight (Mₐ) of ≥500 g/mol to ≤6000 g/mol and a number-average functionality of the sum total of the components b) of ≥1.8 to ≤2.5.

c) at least one chain extender having a molecular weight (Mn) of 60-450 g/mol and a number-average functionality of the sum total of the chain extenders c) of 1,8 to 2.5.

For synthesis of this thermoplastic polyurethane elastomer (TPU), specific examples of isocyanate components a) include: aliphatic diisocyanates such as ethylene diisocyanate, tetramethylene 1,4-diisocyanate, pentamethylene 1,5-diisocyanate, hexamethylene 1,6-diisocyanate, dodecane 1,12-diisocyanate, cycloaliphatic diisocyanates such as isophorone diisocyanate, cyclohexane 1,4-diisocyanate, 1-methylcyclohexane 2,4-diisocyanate and 1-methylcyclohexane 2,6-diisocyanate and the corresponding isomer mixtures, dicyclohexylmethane 4,4′-diisocyanate, dicyclohexylmethane 2,4′-diisocyanate and dicyclohexylmethane 2,2′-diisocyanate and the corresponding isomer mixtures, and also aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates or diphenylmethane 2,4′-diisocyanates, 4,4′-diisocyanato-1,2-diphenylethane and naphthylene 1,5-diisocyanate. Preferably employed are hexamethylene 1,6-diisocyanate, cyclohexane 1,4-diisocyanate, isophorone diisocyanate, dicyclohexylmethane diisocyanate, diphenylmethane diisocyanate isomer mixtures having a diphenylmethane 4,4′-diisocyanate content of more than 96% by weight and especially diphenylmethane 4,4′-diisocyanate and naphthylene 1,5-diisocyanate. The diisocyanates mentioned may be employed singly or in the form of mixtures with one another. They may also be used together with up to 15 mol % (based on total diisocyanate) of a polyisocyanate, but the maximum amount of polyisocyanate that may be added is such as to result in a product that is still thermoplastically processible. Examples of polyisocyanates are triphenylmethane 4,4′,4″-triisocyanate and polyphenylpolymethylene polyisocyanates.

Examples of longer-chain isocyanate-reactive compounds covered by b) include those having on average at least 1.8 to 3.0 Zerewitinoff-active hydrogen atoms and a number-average molecular weight of 500 to 10 000 g/mol. These include, in addition to compounds having amino groups, thiol groups or carboxyl groups, especially compounds having two to three, preferably two, hydroxyl groups, specifically those having number-average molecular weights Mn of 500 to 6000 g/mol, particularly preferably those having a number-average molecular weight Mn of 600 to 4000 g/mol, for example hydroxyl group-containing polyester polyols, polyether polyols, polycaprolactones, polycarbonate polyols and polyester polyamides. Suitable polyester diols may be produced by reacting one or more alkylene oxides having 2 to 4 carbon atoms in the alkylene radical with a starter molecule containing two active hydrogen atoms in bonded form. Examples of alkylene oxides include: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides may be used individually, in alternating succession or as mixtures. Contemplated starter molecules include for example water, amino alcohols, such as N-alkyldiethanolamines, for example N-methyldiethanolamine, and diols such as ethylene glycol, 1,3-propylene glycol, butane-1,4-diol and hexane-1,6-diol. It is optionally also possible to use mixtures of starter molecules. Suitable polyether diols further include the hydroxyl-containing polymerization products of tetrahydrofuran, it is also possible to use trifunctional poly ethers in proportions of 0% to 30% by weight, based on the bifunctional polyether diols, but at most in such an amount as to result in a product that is still thermoplastically processible. The essentially linear polyether diols preferably have number-average molecular weights n of 500 to 6000 g/mol. They may be used either singly or in the Form of mixtures with one another.

Suitable polyester diols may he produced, for example, from dicarboxylic acids having 2 to 12 carbon atoms, preferably 4 to 6 carbon atoms, and polyhydric alcohols. Contemplated dicarboxylic acids include for example: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids may be used individually or as mixtures, for example in the form of a succinic, glutaric and adipic acid mixture. To produce the polyester diols, it may in sonic cases be advantageous to employ not the dicarboxylic acids but rather the corresponding dicarboxylic acid derivatives such as carboxylic diesters having 1 to 4 carbon atoms in the alcohol radical, carboxylic anhydrides or carbonyl chlorides. Examples of polyhydric alcohols include glycols having 2 to 10, preferably 2 to 6, carbon atoms, for example ethylene glycol, diethylene glycol, 1,4-butanediol, 1,5-pentamediol, 1,6-hexanediol, 1,10-decanediol, 2,2-dimethyl-1,3-propanediol, 1,3-propanediol or dipropylene glycol. Depending on the desired properties, the polyhydric alcohols may be used alone or in admixture with one another. Also suitable are esters of carbonic acid with the recited diols, especially those having 4 to 6 carbon atoms, such as butane-1,4-diol or hexane-1,6-diol, condensation products of co-hydroxycarboxylic acids such as re-hydroxyproline acid, or polymerization products of lactones, for example optionally substituted to-caprolactone. Preferably employed polyester diols are ethanediol polyadipates, butane-1,4-diol polyadipates, ethanediol butane-1,4-diol polyadipates, hexane-1,6-diol neopentyl glycol polyadipates, hexane-1,6-diol butane-1,4-diol polyadipates, and polycaprolactones. The polyester diols preferably have number-average molecular weights Mn of 450 to 6000 g/mol and can he employed individually or in the form of mixtures with one another.

The chain extenders c) have on average 1.8 to 3.0 Zerewitinoff-active hydrogen atoms and have a molecular weight of 60 to 450 g/mol. This is to be understood as meaning compounds having amino groups, thiol groups or carboxyl groups, but also those having two to three, preferably two, hydroxyl groups.

Preferably employed chain extenders are aliphatic diols having 2 to 14 carbon atoms, for example ethanediol, propane-1,2-diol, propane-1,3-dial, butane-1,4-diol, butane-2,3-diol, pentane-1,5 diol, hexane-1,6-diol, diethylene glycol and dipropylene glycol. Also suitable, however, are diesters of terephthalic acid with glycols having 2 to 4 carbon atoms, for example terephthalic acid bis-ethylene glycol or terephthalic acid bis-butane-1,4-diol, hydroxyalkylene ethers of hydroquinone, for example 1,4-di(b-hydroxyethyl)hydroquinone, ethoxylated bisphenols, for example 1,4-di(b-hydroxyethyl)bisphenol A, (cyclo)aliphatic diamines, such as isophoronediamine, ethylenediamine, propylene-1,2-diamine, propylene-1,3-diamine, N-methylpropene-1,3-diamine, N,N′-dimethylethylenediamine and aromatic diamines such as tolerate-2,4-diamine, tolylene-2,6-diamine, 3,5-diethyltotylene-2,4-diamine or 3,5-diethyltotylene-2,6-diamine or primary mono-, di-, tri- or tetraalkyl-substituted 4,4′-diaminodiphenylmethanes. Chain extenders employed with particular preference are ethanediol, butane-1,4-diol, hexane-1,6-diol, 1,4-di(β-hydroxyethyl)hydroquinone or 1,4-di(β-hydroxyethyl)bisphenol A. Mixtures of the abovementioned chain extenders may also be employed.

In addition, relatively small amounts of triols may also be added.

Compounds monofunctional toward isocyanates may be employed as so-called chain terminators under f) in proportions of up to 2% by, weight based on TPU, Suitable examples include monoamines such as butyl- and dibutylamine, octylamine, stearylamine, N-methylstearylamine, pyrrolidine, piperidine or cyclohexylamine, monoalcohols such as butanol, 2-ethylhexanol, octane, dodecanol, stearyl alcohol, the various amyl alcohols, cyclohexanol and ethylene glycol monomethyl ether.

The isocyanate-reactive substances should preferably be chosen such that their number-average functionality does not significantly exceed two if thermoplastically processible polyurethane elastomers are to be produced. If higher-functional compounds are used, the overall functionality should accordingly be lowered using compounds having a functionality of <2.

The relative amounts of isocyanate groups and isocyanate-reactive groups are preferably chosen such that the ratio is 0.9:1 to 1.2:1, preferably 0.95:1 to 1.1:1.

The thermoplastic polyurethane elastomers used in accordance with the invention may contain as auxiliary and/or additive substances not more than 50% by weight, based on the total amount of TPU, of customary auxiliary and additive substances. Typical auxiliary and additive substances are catalysts, antiblocking agents, inhibitors, pigments, colorants, flame retardants, stabilizers against aging and weathering effects and against hydrolysis, light, heat and discoloration, plasticizers, lubricants and demolding agents, fungistatic and bacteriostatic substances, reinforcers and inorganic and/or organic fillers and mixtures thereof.

Examples of additive substances are lubricants, such as fatty acid esters, metal soaps thereof, fatty acid amides, fatty acid ester amides and silicone compounds, and reinforcers, for example fibrous reinforcers, such as inorganic fibers, which are produced according to the prior art and may also be treated with a size. Further information about the recited auxiliary and additive substances may be found in the specialist literature, for example in the monograph by J. H. Saunders and K. C. Frisch “High Polymers”, Volume XVI, Polyurethanes, Part 1 and 2, Interscience Publishers 1962/1964, in “Taschenbuch für Kunststoff-Additive” by R. Gächter and H. Müller (Hanser Verlag Munich 1990) or in DE-A 29 01 774.

Suitable catalysts are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and the like and also in particular organic metal compounds such as titanate esters, iron compounds or tin compounds such as tin diacetate, tin dioctoate, tin dilaurate or the dialkyltin salts of aliphatic carboxylic acids such as dibutyitin diacetate dibutyltin dilaurate or the like. Preferred catalysts are organic metal compounds, in particular titanate esters, iron compounds and tin compounds. The total amount of catalysts in the TPUs employed is generally about 0% to 5% by weight, preferably 0% to 2% by weight, based on the total amount of TPU.

In a further preferred embodiment of the process according to the invention the meltable polymer is a thermoplastic elastomer and has a melting range (DSC, differential scanning calorimetry; 2nd heating at a heating rate of 5 K/min) of ≥20 ° C. ≤100 ° C. and a magnitude of complex viscosity |η^{*}| (determined by viscometry measurement in the melt with a plate/plate oscillation shear viscometer at 100° C. and at an angular frequency of 1/s as per ISO 6721-10:2015-09) of ≥10 Pas to ≤1 000 000 Pas.

This thermoplastic elastomer has a melting range of ≥20° C. to ≤100° C., preferably of ≥25° C. to ≤90° C. and more preferably of ≥30° C. to ≤80° C. In the DSC analysis for determination of the melting range, the material is subjected to the following temperature cycle: 1 minute at −60° C., then heating to 200° C. at 5 kelvin/minute, then cooling to −60° C. at 5 kelvin/minute, then 1 minute at −60° C., then heating to 200° C. at 5 kelvin/minute.

It is possible that the temperature interval between the start of the melting operation and the end of the melting operation as determinable according to the above DSC protocol is ≤20° C., preferably ≤10° C. and more preferably ≤5° C.

This thermoplastic elastomer further has a magnitude of complex viscosity |η^{*}| (determined by viscometry measurement in the melt with a plate/plate oscillation viscometer according to ISO 6721-10:2015-09 at 100° C. and an angular frequency of 1/s) of ≥10 Pas to ≤1 000 000 Pas. |η^{*}| is preferably ≥100 Pas to ≤500 000 Pas, more preferably ≥1000 Pas to ≤200 000 Pas. It is further preferred when |η^{*}| is ≥500 Pas to ≤200 000 Pas.

The magnitude of complex viscosity |η^{*}| describes the ratio of the viscoelastic moduli G′ (storage modulus) and G″ (loss modulus) to the excitation frequency ω in a dynamic-mechanical material analysis:

$$\vert {η}^{*} \vert = \sqrt{[ {( \frac{{G}^{′}}{ω} )}^{2} + {( \frac{{G}^{″}}{ω} )}^{2} ]} = \frac{\vert {G}^{*} \vert}{ω}$$

This thermoplastic elastomer is preferably a thermoplastic polyurethane elastomer:

In a further preferred embodiment of the process according to the invention the meltable polymer is a thermoplastic polyurethane elastomer obtainable from the reaction of a polyisocyanate component and a polyol component, wherein the polyol component comprises a polyesterpolyol having a no-flow point (ASTM D5985) of ≥25° C.

Optionally also employable as chain extenders in the reaction to afford this polyurethane are diols in the molecular weight range from ≥62 to ≤600 g/mol.

This polyisocyanate component may comprise a symmetric polyisocyanate and/or an asymmetric polyisocyanate. Examples of symmetric polyisocyanates are 4,4′-MDI and HDI.

In the case of asymmetric polyisocyanates the steric environment of one NCO group in the molecule is different from the steric environment of a further NCO group. One isocyanate group then reacts more quickly with isocyanate-reactive groups, for example OH groups, while the remaining isocyanate group is less reactive. One consequence of the asymmetric construction of the polyisocyanate is that the polyurethanes formed with these polyisocyanates also have a less linear structure.

Examples of suitable asymmetric polyisocyanates are selected from the group comprising: 2,2,4-trimethylhexamethylene diisocyanate, ethylethylene diisocyanate, nonsymmetric isomers of dicyclohexylmethane diisocyanate (H₁₂-MDI), asymmetric isomers of 1,4-diisocyanatocyclohexane, asymmetric isomers or 1,3-diisocyanatocyclohexane, asymmetric isomers of 1,2-diisocyanatocyclohexane, asymmetric isomers of 1,3-dilsocyanatocyclopentane, asymmetric isomers of 1,2-diisocyanatocyclopentane, asymmetric isomers of 1,2-diisocyanatocyclobutane, 1-isocyanatomethyl-3-isocyanato-1,5,5-trimethylcyclohexane (isophorone diisocyanate, IPDI), 1-methyl-2,4-diisocyanatocyclohexane, 1,6-diisocyanato-2,2,4-trimethylhexane, 1,6-diisocyanato-2,4,4-trimethylhexane, 5-isocyanato-1-(3-isocyanatoprop-1-yl)-1,3,3 -trimethylcyclohexane, 5-isocyanato-1-(4 -isocyanatobut-1-yl)-1,3,3-trimethylcyclohexane, 1-isocyanato-2-(3-isocyanatoprop-1-y)cyclohexane, 1-isocyanato-2-(2-isocyanatoeth-1-yl)cyclohexane, 2-heptyl-3,4-bis(9-isocyanatononyl)-1-pentylcyclohexane, norbornane diisocyanatornethyl, diphenylmethane 2,4′-diisocyanate (MDI), tolylene 2,4- and 2,6-diisocyanate (TDI), derivatives of the diisocyanates listed, especially dimerized or trimerized types, or a combination of at least two of these.

Preference is given to 4,4′-MDI or a mixture containing IPDI and HDI and/or PDI as the polyisocyanate component.

This polyol component comprises a polyester polyol having a no-flow point (ASTM D5985) of ≥25° C., preferably ≥35° C., more preferably ≥35° C. to ≤55° C. To determine the no-flow point a test vessel containing the sample is set into slow rotation (0.1 rpm). A flexibly mounted measuring head is immersed in the sample and, on attainment of the no-flow point, is moved away from its position as a result of the abrupt increase in viscosity; the resulting tipping motion triggers a sensor.

Examples of polyesterpolyols which can have such a no-flow point are reaction products of phthalic acid, phthalic anhydride or symmetric α, ω-C₄- to C₁₀-dicarboxylic acids with one or more C₂- to C₁₀-diols. They preferably have a number-average molecular weight Mₙ of ≥400 g/mol to ≤6000 g/mol. Suitable dials are especially monoethylene glycol, butane-1,4-diol, hexane-1,6-diol and neopentyl glycol.

Preferred polyesterpolyols are specified hereinbelow by reporting their acid and diol components: adipic acid +monoethylene glycol; adipic acid +monoethylene glycol +butane-1,4-diol; adipic acid +butane-1,4-diol; adipic acid +hexane-1,6-diol +neopentyl glycol; adipic acid +hexane-1,6-diol; adipic acid +butane-1,4-diol +hexane-1,6-diol; phthalic acid(anhydride) +monoethylene glycol +trimethylolpropane; phthalic acid(anhydride) +monoethylene glycol. Preferred polyurethanes are obtained from a mixture containing IPDI and HDI as the polyisocyanate component and a polyol component comprising an abovementioned preferred polyosterpolyol. Particularly preferred for constructing the polyurethanes is the combination of a mixture containing IPDI and HDI as the polyisocyanate component with a polyesterpolyol formed from adipic acid +butane-1,4-diol hexane-1,6-diol.

It is further preferred when these polyester polyols have an OH number (DIN 53240) of ≥25 to ≤170 mg KOH/g and/or a viscosity (75° C., DIN 51550) of ≥50 to ≤5000 mPas.

One example is a polyurethane obtainable from the reaction of a polyisocyanate component and a polyol component, wherein the polyisocyanate component comprises an HDI and IPDI and wherein the polyol component comprises a polyesterpolyol which is obtainable from the reaction of a reaction mixture comprising adipic acid and also hexane-1,6-diol and butane-1,4-diol with a molar ratio of these diols of ≥1:4 to 4:1 and which has a number-average molecular weight Mₙ (GPC, against polystyrene standards) of ≥4000 g/mol to ≤6000 g/mol. Such a polyurethane may have a magnitude of complex viscosity |η^{*}| (determined by viseometry measurement in the melt with a plate/plate oscillation viscometer according to ISO 6721-10;2015-09 at 100° C. and an angular frequency of 1/s) of ≥4000 mPas to ≤160 000 mPas.

A further example of a suitable polyurethane is:

1. Substantially linear polyester polyurethanes having terminal hydroxyl groups as described in EP 0192946 A1, produced by reaction of

a) polyester diols having a molecular weight above 600 and optionally

b) (riots in the molecular weight range of 62 to 600 g/mol as chain extenders with

c) aliphatic diisocyanates,

while observing an equivalent ratio of hydroxyl groups of components a) and b) to isocyanate groups of component c) of 1:0.9 to 1:0.999, wherein component a) consists to an extent of at least 80% by weight of polyester diols in the molecular weight range of 4000 to 6000 based on (i) adipic acid and (ii) mixtures of 1,4-dihydroxybutane and 1,6-dihydroxyhexane in a molar ratio of the diols of 4:1 to 1:4.

In the polyester polyurethanes recited under 1 it is preferable when component a) consists to an extent of 100% of a polyester diol in the molecular weight range of 4000 to 6000 wherein the production thereof has employed as the diol mixture a mixture of 1,4-dihydroxybutane and 1,6-dihydroxyhexane in a molar ratio of 7:3 to 1:2.

In the polyester polyurethanes recited under 1 it is further preferable when component c) comprises IPDI and also HDI.

In the polyester polyurethanes recited under 1 it is further preferable when the production thereof comprised co-use as component b) of alkanediols selected from the group consisting of: 1,2-dihydroxyethane, 1,3-dihydroxypropane, 1,4-dihydroxybutane, 1,5-dihydroxypentane, 1,6-dihydroxyhexane or a combination of at least two of these in an amount of up to 200 hydroxyl equivalent percent based on component a).

It is further possible that after heating to 100° C. and cooling to 20° C. at a cooling rate of 4° C./min over a temperature interval from 25° C. to 40° C. for ≥1 minute (preferably >1 minute to ≤30 minutes, more preferably ≥10 minutes to ≤15 minutes) the thermoplastic elastomer has a storage modulus G′ (determined at the respectively prevailing temperature with a plate/plate oscillation viscometer according to ISO 6721-10:2015-09 at an angular frequency of 1/s) of ≥100 kPa to ≤1 MPa and after cooling to 20° C. and storage for 20 minutes has a storage modulus G′ (determined at 20° C. with a plate/plate oscillation viscometer according to ISO 6721-10:2015-09 at an angular frequency of 1/s) of ≥10 MPa.

In a further preferred embodiment of the process according to the invention the substrate is in the form of a movable conveyor belt having a side carrying the layer comprising particles. This allows continuous or quasi-continuous operation of the process according to the invention.

In a further preferred embodiment each performance of steps V) to VIII) employs a different substrate and/or a layer comprising a different meltable polymer. This may he achieved for example by initially charging different meltable polymers onto a conveyor belt side by side and switching hack and forth between the individual regions in the process. In particular each performance of the steps V) to VIII) may employ different particles comprising meltable polymer.

In a farther preferred embodiment step I) and/or step V) comprise providing the layer on the substrate in such a way that the provided layer including expanded edges corresponds to the selected cross section of the article. It is thus possible to coat not the entire substrate with a powder layer to cover the whole surface but rather only selected regions which in a further preferred embodiment coincide with the regions desired in the subsequent contacting step.

In a further preferred embodiment the respectively selected cross section of the article is subdivided into a plurality of volume elements (voxels), the layer comprising the meltable polymer is in the form of a powder layer, the powder layer comprises a plurality of meltable polymers and the composition of the powder layer for one voxel differs from a further voxel at least in the composition of the powder layer. Applied to the substrate in particular are only selected regions of a powder layer containing different materials on a voxel-specific basis which are specifically melted by a laser according to their melting temperatures. The voxel-specific application of different materials onto a substrate surface may be effected for example by a powder printing process analogous to a classical inkjet process, wherein a plurality of independent printing heads and independent powder materials may be employed. In this way for example through distinctly colored powders full color printing may be economically realized.

In a further preferred embodiment the respectively selected cross section of the article is subdivided into a plurality of volume elements (voxels), the layer comprising the meltable polymer is in the form of a powder layer and a liquid activator (which specifically reduces the irradiated energy necessary for melting) is selectively applied to selected voxels. Thus the powder layer may be applied to the substrate and voxel-specifically provided with a liquid activator which specifically reduces the irradiated energy necessary for melting (solvents, plasticizers, absorption enhancers). This embodiment is advantageous for example for a high-speed sintering process where surface irradiation is used as an activating means, in a further particular embodiment activators and inhibitors are voxel-specifically applied to the powder layer to obtain better edge definition in the activation process.

In a further preferred embodiment the respectively selected cross section of the article is subdivided into a plurality of volume elements (voxels), the layer comprising the multiple polymer is in the form of a powder layer and an adhesion promoter is selectively applied to selected voxels. Thus achievable by specific application of a (reactive) adhesive or solvent is a voxel-specific tackiness which makes only the desired specific regions tacky and thus allows construction of the desired 3D structures in the contacting step.

Present on a substrate instead of a powder in a further preferred embodiment is a thermoplastic coating which as elucidated above is specifically subjected to voxel-specific melting and contacting. Comprised in this specific embodiment are in particular materials having a low viscosity in the melt having a melt viscosity of <1000 Pas, preferably <100 Pas, more preferably 10 Pas (determined by viscometry measurement with a plate/plate oscillation shear viscometer at an angular frequency of Ps according to ISO 6721-10: 2015-09 at a temperature of 20 C above the melting temperature),

A further preferred embodiment employs in steps II) and VI) a plurality of energy beams which are derived from a plurality of photo or laser diodes and which are arranged such that they can project radiation images having a resolution of >10 DPI (dots per inch) onto the powder layer. The radiation images are preferably formed by a process analogous to a DLP projector by means of one or more focused strong radiation sources which project linear and/or two-dimensional images with a plurality of movable mirrors.

The invention further relates to a system for performing the process according to the invention comprising:
a control unit;
a substrate;
an application unit for providing a layer on a substrate, wherein the layer contains a meltable polymer;
an energizing unit for energizing a selected portion of the layer corresponding to a selected cross section of an article to be produced so that the layer in the selected portion are at least partially melted and an at least partially melted volume or a plurality of at least partially molten volumes are obtained;
a contacting unit for contacting the volume or volumes obtained via the energizing unit and for removing this volume or volumes from the substrate;

wherein the energizing unit performs the energizing under command of the control unit and the contacting unit performs the contacting under command of the control unit.

In a preferred embodiment the substrate is in the form of a movable conveyor belt having a side carrying a layer comprising particles and this side has a movement direction, the energizing unit is in the form of an irradiation unit, the application unit is arranged upstream of the energizing unit in the movement direction of the substrate and the energizing unit is arranged upstream of the contacting unit in the movement direction of the substrate.

Such a configuration may be employed in continuous or quasi-continuous operation. In quasi-continuous operation the conveyor belt may he stopped for their radiation and contacting steps and resumed upon completion of these steps. Continuous operation can be achieved by movable irradiation and contacting units which move at the same speed and in the same direction as the conveyor belt during the irradiation and contacting steps,

In a further preferred embodiment the substrate is provided with a thermoplastic coating which functions as the layer comprising the meltable polymer for the purposes of the present invention. What is advantageous in this embodiment is that compared to a powder method the layer thickness may be selected to be significantly lower since there is no risk from dusts. Products having a higher resolution in all 3 spatial dimensions compared to conventional powder processes are accordingly conceivable.

In a further preferred embodiment the substrate moves back and forth between the contacting unit, the energizing unit and the application unit for each individual layer of the article to be constructed.

An example of a system for performing the method according to the invention comprises:
a control unit;
a substrate;
an application unit for applying a layer comprising particles onto the substrate, wherein the particles contain a meltable polymer;
an irradiation unit for irradiating a selected portion of a layer comprising particles corresponding to a selected cross section of an article to be produced with an energy beam or a plurality of energy beams so that the particles in the selected portion are at least partially melted and become joined to afford one volume or a plurality of volumes;
a contacting unit for contacting the volume or volumes formed via the irradiation unit and for removing this volume or volumes from the substrate;

wherein the irradiation unit performs the irradiation under command of the control unit and the contacting unit performs the contacting under command of the control unit.

It is preferable when the substrate is in the form of a movable conveyor belt having a side carrying the layer comprising particles, wherein this side has a movement direction, the application unit is arranged upstream of the irradiation unit in the movement direction of the substrate and the irradiation unit is arranged upstream of the contacting unit in the movement direction of the substrate.

In a particular embodiment of the described invention it is possible to reuse >60%, preferably >70%, preferably >80%, particularly preferably >90%, of the employed powder material or coating material since it is subjected to markedly lower and shorter-term thermal stress.

In a particular embodiment the procedure may be performed in ambient air since oxidative processes are much less relevant due to the shorter thermal stress and accordingly discoloration and other unwanted alteration of the material occurs to a much lesser extent,

The present invention is more particularly elucidated with reference to the figures which follow without, however, being limited thereto,

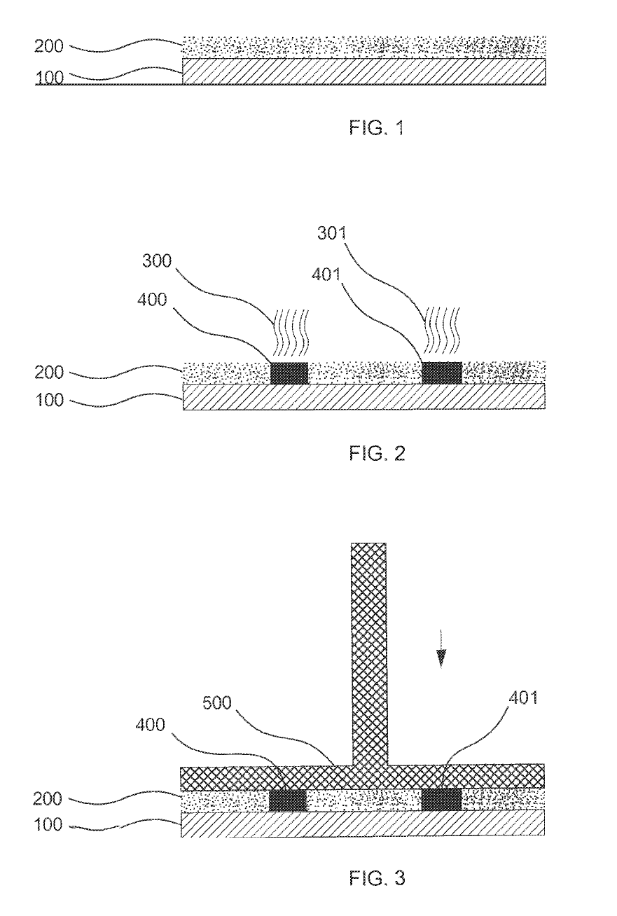

FIGS. 1-8 show the steps of the process according to the invention

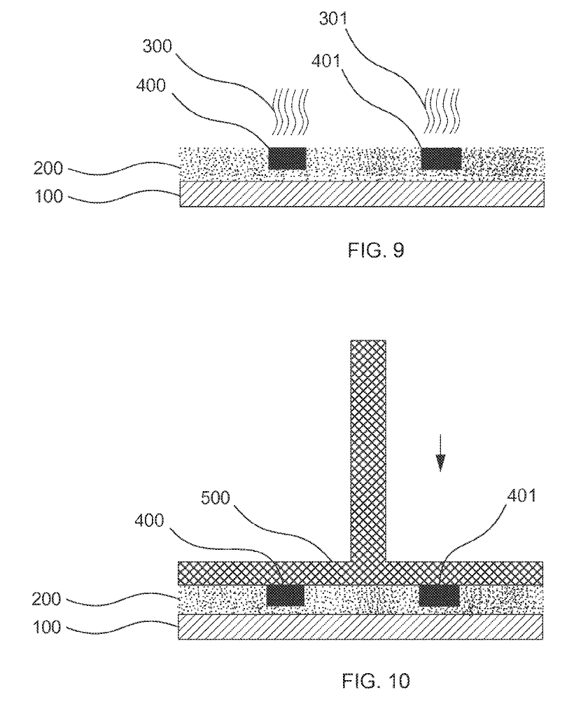

FIGS. 9-14 show the steps of a variant of the process according to the invention

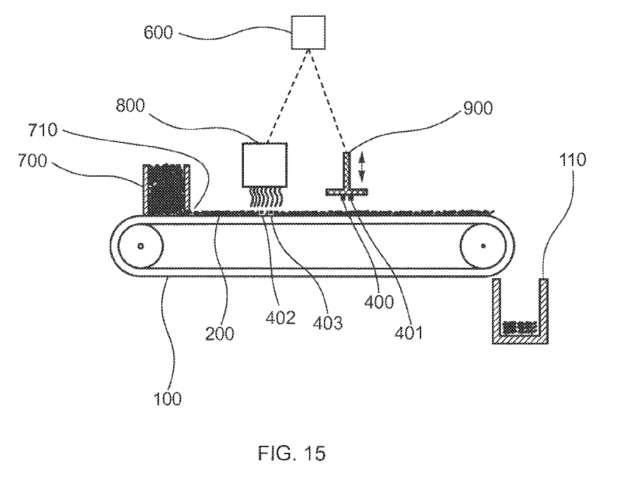

FIG. 15 shows a system according to the invention

FIG. 1 is a schematic diagram of step I) of the process according to the invention in which the construction of the first layer of the article to be produced is initiated. A layer comprising particles 200 is applied to a substrate 100, This may comprise application of the particles by blade coating.

Subsequently, according to step II) and as shown in FIG. 2, the layer 200 is irradiated. This is carried out according to a first selected cross section of the article using energy beams in the form of laser beams 300, 301. Where the laser beams 300, 301 energize the particle layer 200 the particles/the meltable polymer present therein are melted such that they become joined to one another to afford volumes 400 and 401. The melting also causes the meltable polymer to become tacky.

The steps of the process according to the invention shown in FIGS. 1 to 14 are of a schematic nature as concerns the melting of the particles. One possible behavior of employable materials in the process according to the invention is that starting from the powder the powder melt has a >10% higher density than the powder as a result of which a meniscus of the melt is typically below the original powder surface and the contacting process includes a partial compression and/or displacement of the powder surface. Such behavior is included according to the invention.

Before the previously molten material can revert to a non-tacky state, according to step III) and as shown in FIG. 3, a carrier 500 in the form of a piston is lowered onto the material. The piston 500 contacts the volumes 400 and 401 obtained by the melting. As a result of their tackiness these volumes become joined to the surface of the piston 500 contacting them.

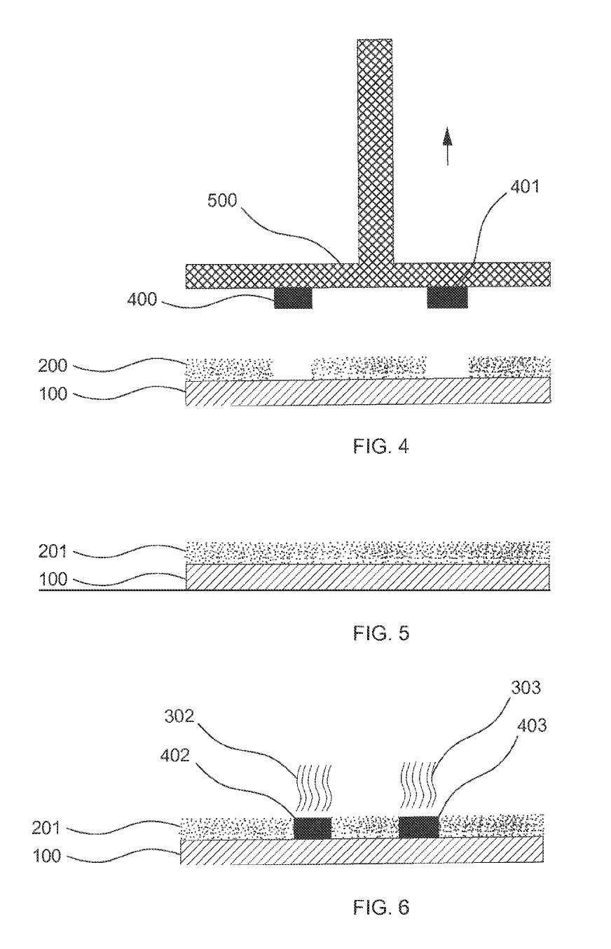

Subsequently, according to step IV)/FIG. 4, the piston 500 is moved vertically upward to remove the volumes 400 and 401 from the substrate 100. Where the particle layer 200 has not been melted by laser energizing it remains intact.

Once the first cross section of the article to be produced is joined to the piston 500, further cross sectional plies may be joined to material already present on the piston 500. This is carried out until the article to be produced is obtained.

According to FIG. 5/step V) a new complete particle layer 201 is provided on the substrate 100, for example again by blade coating.

According to FIG. 6/step VI) a selected portion of the particle layer 201 corresponding to a further selected cross section of the article to be produced is irradiated by energy beams in the form of laser beams 300, 302. The particles/the meltable polymer present therein are melted such that they become joined to one another to afford volumes 402 and 403. The meltable polymer is also converted into a tacky state by melting.

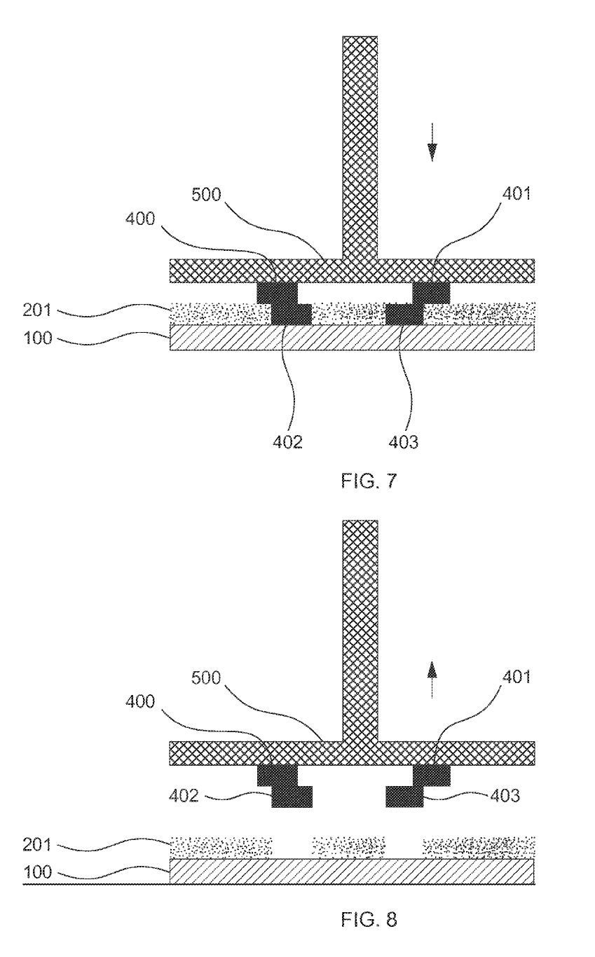

FIG. 7/step VII) shows how the piston 500 together with the volumes 400 and 401 adhering to it is lowered so that the volumes 400 and 401 can contact the molten volumes 402 and 403 to interconnect them.

Subsequently, according to FIG. 8/step VIII) the piston 500 is raised. Since volume 402 has become joined to volume 400 and volume 403 has become joined to volume 401 these volumes are likewise raised and detached from the substrate 100.

This cycle—applying a particle layer, irradiating, contacting and detaching—is now performed until the article has been formed.

FIGS. 9 to 14 represent a schematic description of a preferred embodiment of the process according to the invention. In this embodiment the melting steps II) (for the first layer) and VI) (for all subsequent layers) are performed such that the volumes obtained after the melting do not contact the substrate. A particle layer is then still present between the volumes and the substrate, thus rendering the adhesion between the volume and substrate practically nonexistent.

FIG. 9 shows the melting step II) in which the energy input of the lasers 300, 301 is measured such that as yet unmelted particle layers remain between the volumes 400 and 401 and the substrate 100,

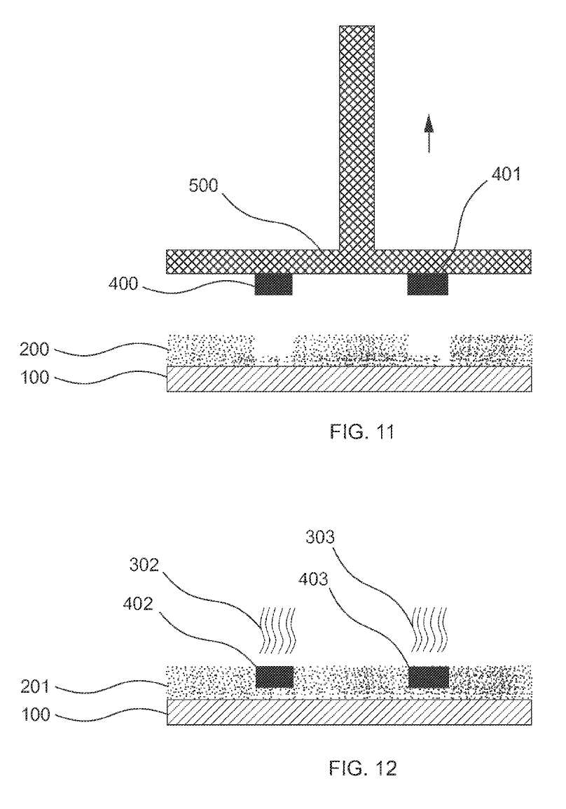

After the contacting of the volumes 400 and 401 with the piston 500 (FIG. 10) the lifting of the piston 500, together with the volumes 400 and 401, is carried out (FIG 11).

FIG. 12 shows how after re-application of the particle layer 201 (cf. FIG. 5/step V)) in the melting step VI) the laser beams 302 and 304 melt the meltable polymer in selected regions of the particle layer to afford volumes 402 and 403, wherein unmelted particle layers in turn remain between the volumes 402 and 403 and the substrate 100.

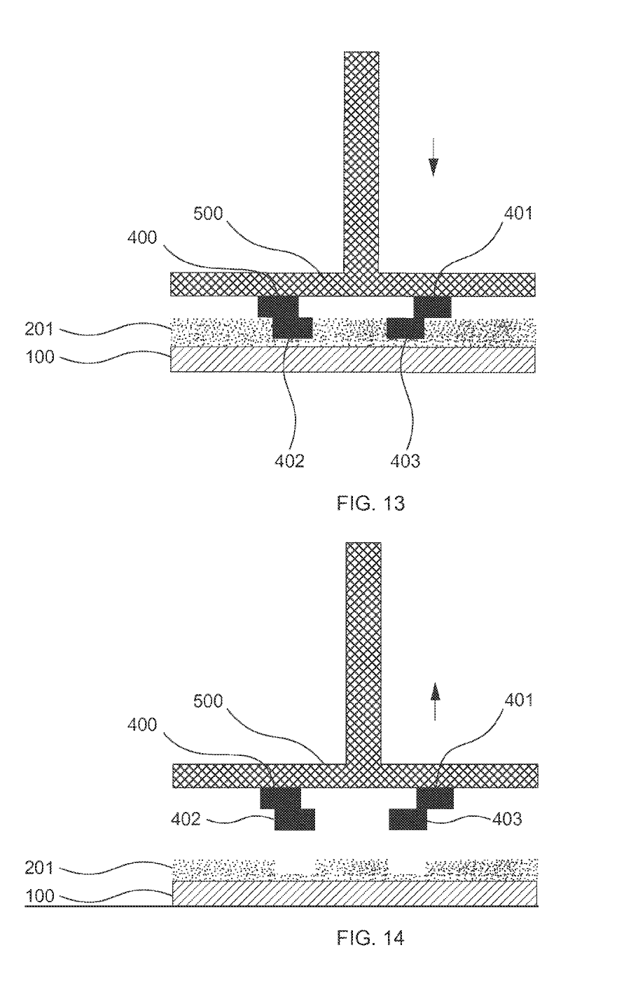

The contacting of the obtained volumes 402 and 403 with volumes 400 and 401 already joined to the piston 500 (FIG. 13) and the raising of the piston together with the volumes 402 and 403 (FIG, 14) are carried out analogously to the procedures shown in FIGS. 7 and 8.

FIG. 15 shows a system according to the invention. In the system the substrate 100 is in the form of a movable recirculating conveyor belt. The movement direction of the upward facing side of the substrate 100 is from left to right in the figure.

The application unit 700 also serves as a reservoir vessel for the particles comprising multiple polymer. Via a slot 710 the particles reach the moving substrate 100 and thus form the particle layer 200. The height of the slot 710 can be used to control the height of the particle layer.

In response to commands from the control unit 600 the irradiation unit 800 irradiates a selected portion of the particle layer 200. The bidirectional flow of commands and control data is represented by the dashed line between the control unit 600 and the irradiation unit 800.

As a result of the irradiation the molten volumes 402 and 403 are formed. The movement of the substrate 100 transports said volumes onward to the contacting unit 900 arranged downstream of the irradiation unit 800 in the movement direction of the substrate.

In response to commands from the control unit 600 the contacting unit 900 in the form of a piston can move up and down and thus contact the volumes of the at least partially melted material disposed below it. This takes place provided that the material still exhibits sufficient tackiness. The bidirectional flow of commands and control data is represented by the dashed line between the control unit 600 and the contacting unit 900.

When the previously formed volumes 402 and 403 arrive below the contacting unit 900, said unit moves downward This results in an adhesion between the volumes 402 and 403 and the volumes 400 and 401 already adhering to the contacting unit 900.

The unirradiated proportions of the particle layer 200 are transported into a collection container 110 by the movement of the substrate 180, optionally in combination with a doctor blade (not shown). Said proportions may then be sent back for reuse, optionally after a filtration process to separate out clumped proportions, in particular by transferal into the application unit 700.

1.-15. (canceled)

16. A process for producing an article comprising the steps of:
I) providing a layer on a substrate, wherein the layer contains a meltable polymer;
II) energizing a selected portion of the layer provided in step I) corresponding to a first selected cross section of the article so that the layer in the selected portion is at least partially melted and at least one at least partially melted volume is obtained;
III) contacting the at least one volume obtained in step II) with a carrier so that the at least one volume is joined to the carrier;
IV) removing the carrier including the at least one volume joined to the carrier from the substrate;
V) providing a further layer on the substrate or on a further substrate, wherein the layer contains a meltable polymer;
VI) energizing a selected portion of the layer provided in step V) corresponding to a further selected cross section of the article so that the layer in the selected portion is at least partially melted and at least one at least partially melted volume is obtained;
VII) contacting the at least one volume obtained in step VI) with at least one of the volumes previously joined to the carrier so that the volume obtained in step VI) is joined to at least one of the volumes previously joined to the carrier;
VIII) removing the carrier including the volumes joined to the carrier from the substrate;
IX) repeating steps V) to VIII) until the article is formed.

17. The process as claimed in claim 16, wherein the steps II) and/or VI) are performed such that the energizing of the selected portion of the layer is carried out by irradiation with an energy beam or a plurality of energy beams.

18. The process as claimed in claim 16, wherein the steps II) and/or VI) are performed such that they comprise initially applying a liquid onto the selected portion of the layer, wherein the liquid increases the absorption of energy in the regions of the layer contacted by it relative to the regions not contacted by it, and subsequently subjecting the layer to an energy source.

19. The process as claimed in claim 16, wherein the steps I) and/or V) are performed such that a layer comprising particles is applied to the substrate, wherein the particles contain a meltable polymer.

20. The process as claimed in claim 16, wherein the steps I) and/or V) are performed such that a film containing a meltable polymer is provided, wherein the film is arranged on a carrier film as a substrate.

21. The process as claimed in claim 16, wherein the contacting in step III) and/or step VII) is performed such that it comprises performing a relative movement of the carrier toward the substrate, monitoring the distance between the carrier and the substrate and/or between the carrier and the surface of the layer and interrupting the relative movement upon falling below a predetermined distance.

22. The process as claimed in claim 16, wherein the contacting in step III) and/or step VII) is performed such that it comprises performing a relative movement of the carrier toward the substrate, monitoring the contact pressure between the carrier and the substrate and/or between the carrier and the surface of the layer and interrupting the relative movement upon exceedance of a predetermined contact pressure.

23. The process as claimed in claim 16, wherein the meltable polymer is selected such that a droplet of the meltable polymer in the molten state has a contact angle to the substrate used in the process of ≥60° to ≤180°
and/or
the meltable polymer is selected such that a droplet of the meltable polymer in the molten state has a contact angle to the carrier used in the process of ≥0° to ≤90°.

24. The process as claimed in claim 16, wherein the steps II) and/or VI) are performed such that the at least one obtained volume does not contact the substrate.

25. The process as claimed in claim 16, wherein the steps II) and/or VI) are performed such that after the at least partial melting of the particles their molten material at a temperature of ≥20° C. above the melting point of their material has a storage modulus G′ (determined by viscometric measurement with a plate/plate oscillation shear viscometer at an angular frequency of 1/s) of ≥5·10³ Pa to ≤1·10⁷ Pa.

26. The process as claimed in claim 16, wherein the steps III) and/or VII) are performed such that volumes previously joined to the carrier have a storage modulus G′ (determined by viscometric measurement with a plate/plate oscillation shear viscometer at an angular frequency of 1/s) of >1·10⁷ Pa.

27. The process as claimed in claim 16, wherein the meltable polymer is selected from the group consisting of polyurethane, polyester, polyalkylene oxide, plasticized PVC, polyamide, protein, PEEK, PEAK, polypropylene, polyethylene, thermoplastic elastomer, POM, polyacrylate, polymethylmethacrylate, polystyrene, polycarbonate or a combination of at least two of these.

28. The process as claimed in claim 16, wherein the substrate is in the form of a movable conveyor belt having a side carrying the layer comprising particles.

29. A system for performing the process as claimed in claim 16 comprising:
a control unit;
a substrate;
an application unit for providing a layer on a substrate, wherein the layer contains a meltable polymer;
an energizing unit for energizing a selected portion of the layer corresponding to a selected cross section of an article to be produced so that the layer in the selected portion are at least partially melted and an at least partially melted volume or a plurality of at least partially molten volumes are obtained;
a contacting unit for contacting the volume or volumes obtained via the energizing unit and for removing this volume or volumes from the substrate;
wherein the energizing unit performs the energizing under command of the control unit and the contacting unit performs the contacting under command of the control unit.

30. The system as claimed in claim 29, wherein
the substrate is in the form of a movable conveyor belt having a side carrying a layer comprising particles and this side has a movement direction;
the energizing unit is in the form of an irradiation unit;
the application unit is arranged upstream of the energizing in the movement direction of the substrate and
the energizing unit is arranged upstream of the contacting unit in the movement direction of the substrate.
